(19) United States
(12) Patent Application Publication
(10) Pub. No.: US 2006/0262278 A1
(43) Pub. Date: Nov. 23, 2006

(54) PROJECTOR HAVING A DETACHABLE LIGHT MODULE

(75) Inventor: Yueh-Jen Chen, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ CORPORATION, Taoyuan Shien (TW)

(21) Appl. No.: 11/381,560

(22) Filed: May 4, 2006

(30) Foreign Application Priority Data
May 19, 2005 (TW) 94116303

(51) Int. Cl. G03B 21/26

(52) U.S. Cl. 353/30

(57) ABSTRACT

A projector includes a light module and an optical engine. The light module includes a fixture, at least a light source and a light guide element. The light source, disposed on the fixture, is for emitting a light along a direction. The light guide element, disposed on the fixture and adjacent to the light source, is for changing the direction of the light. The optical engine, disposed near the light module, is for receiving the light emitted from the light guide element and for generating an image. The fixture is detachably disposed on a projector, so that the light module is detachably disposed on the projector.

This application claims the benefit of Taiwan Application Serial Number 94116303, filed May 19, 2005, the subject matter of which is incorporated herein by reference.

### BACKGROND OF THE INVENTION

1. Field of the Invention

The present invention relates to a projector, and more particularly, to a projector having a detachable light module.

2. Description of the Related Art

A light source of a projector is usually a lamp. In a conventional projector, a lamp is used for generating a light along a direction, and an optical device is used for changing the direction of the light. An optical engine receives the light from the lamp, for generating an image, and for then emitting the image onto the screen.

In the conventional projector, only the lamp is a detachable device. Unlike the lamp, the optical device, such as a condensing lens or a prism, is fixedly disposed in the optical engine. When the researchers or developers change the design of the lamp with a different specification, a new optical path occurs. To accommodate the new optical path of the changed lamp, the researchers or developers must also change the design of the optical engine. Changing the design of the optical engine increases the cost and complexity of changing the lamp, and wastes a lot of time and manpower. When the optical device is damaged, on the other hand, repairing or maintaining the optical device is not an easy job since the optical device is fixedly disposed and is not detachable.

### SUMMARY OF THE INVENTION

It is an object of the present invention to provide a projector assembly. In the projector assembly, the light source is modularized so that the light module is detachably disposed in a projector. This disposition simplifies a designing process of changing the light module.

The invention achieves the above-identified object by providing a projector assembly, which comprises a light module and an optical engine. The light module comprises a fixture, at least a light source and a light guide element. The light source, disposed on the fixture, is for emitting a light along a direction. The light guide element, disposed on the fixture and adjacent to the light source, is for changing the direction of the light. The optical engine, disposed near the light module, is for receiving the light emitted from the light guide element and for generating an image. The fixture is detachably disposed on a projector, so that the light module is detachably disposed on the projector.

The invention achieves the above-identified object by providing a projector, which comprises a housing, a light module and an optical engine. The light module comprises a fixture, a first light source and a second light source, a first light condensing device, a second light condensing device and a light guide element. The fixture may have an exit slit. The first light source and a second light source, detachably disposed on the fixture, are for respectively emitting a first light and a second light. The first light condensing device and the second light condensing device, respectively disposed beside the first light source and the second light source, are for condensing the first light and the second light. The light guide element is for guiding the condensed first light and the condensed second light to the exit slit. The optical engine, disposed in the housing and near the light module, is for receiving the first light and the second light emitted from the light module and for generating an image.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 depicts a perspective view showing an optical path of a projector in accordance with a first embodiment of the invention;

FIG. 2 depicts a perspective view showing a projector assembly in accordance with the first embodiment of the invention;

FIG. 3 depicts an exploding view showing the light module in FIG. 2;

FIG. 4 depicts a perspective view showing the detached light module and the projector in FIG. 2;

FIG. 5 depicts a perspective view showing the detached first light source and the detached second light source and the projector in FIG. 2; and

FIG. 6 depicts a perspective view showing an optical path of a projector in accordance with a second embodiment of the invention.

### DETAILED DESCRIPTION OF THE PREFERRED EMBODIMENT

In a projector assembly of the invention, the light module is detachably disposed in a projector. The projector includes an optical engine and an interface between the optical engine and the light module. The interface is simply made, so that the design of the light module can be changed without changing the design of the optical engine. As a result, the designing process of changing the light module is simplified. On the other hand, the cost and time of changing the design of the optical engine are therefore saved.

### First Embodiment

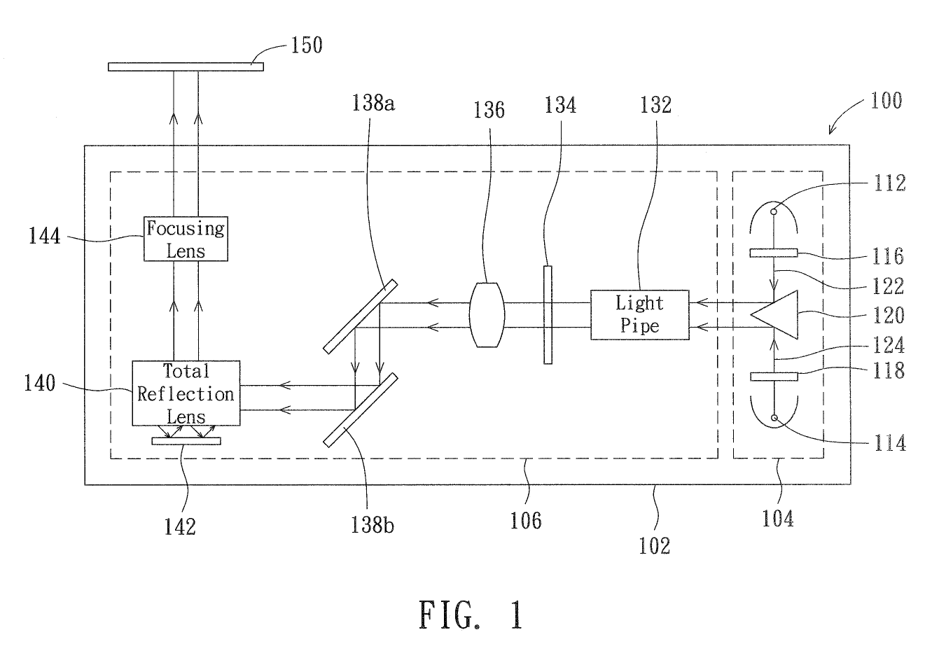

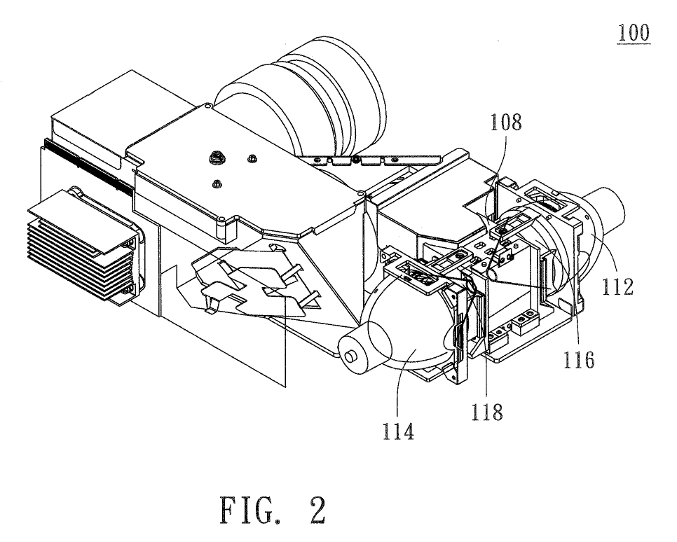

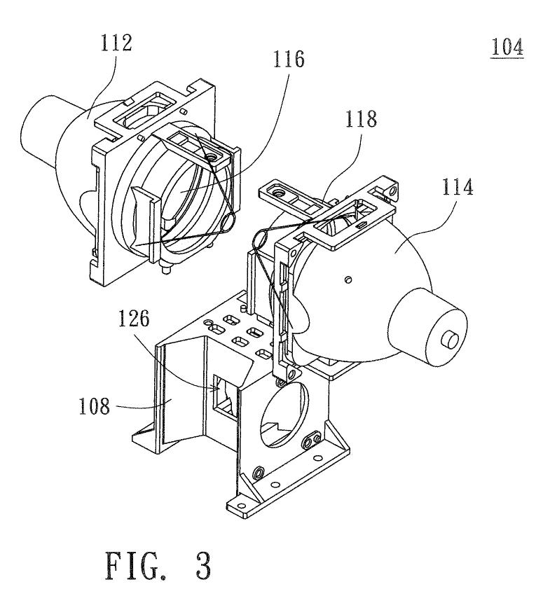

FIG. 1 depicts a perspective view showing an optical path of a projector according to a first embodiment of the invention. FIG. 2 depicts a perspective view showing a projector assembly according to the first embodiment of the invention. FIG. 3 depicts an exploding view showing the light module in FIG. 2. Reference is made to FIG. 1, FIG. 2 and FIG. 3, the projector assembly of the first embodiment comprises a double-lamps projector 100 having a housing 102, a light module 104 and an optical engine 106.

The light module comprises a fixture 108, at least a light source and a light guide element 120. The light module preferably further includes a first light condensing device 116 and a second light condensing device 118. The fixture 108 may have an exit slit 126, and may be detachably disposed on a projector 100. The fixture 108 is disposed, for example, by being screwed on the housing 102 with a bolt, so that the fixture is detachably disposed on the projector 100.

The light source, such as a lamp, disposed on the fixture 108, is for emitting a light. The light source may be fixedly disposed on the light module 104. Alternatively, the light source is detachably disposed on the fixture 108 by, for example, being screwed on the fixture 108 with a bolt, so that the light source is detachably disposed on the light module 104.

In the projector 100 of the first embodiment, the light module 104 comprises a first light source 112 and a second light source 114. The first light source 112 and the second light source 114, disposed on two opposite sides of the fixture 108, are for respectively emitting a first light 122 and a second light 114. The first light source 112 and the second light source 114 are screwed on the fixture with a bolt, so that each of the first light source 112 and the second light source 114 can be individually detached.

Light guide element 120 is, for example, a prism or a fold mirror. The light guide element 120, disposed on the fixture 108 and near the light source, is for changing the emitting direction of the first light 122 and the second light 124. The light guide element 120 is disposed, for example, on the first light source 112 and the second light source 114, for changing the emitting direction of the first light 122 and the second light 124.

The first light condensing device 116 and the second light condensing device 118 are, for example, two condensing lenses. The first light condensing device 116 is, for example, disposed between the first light source 112 and the light guide element 120. The second light condensing device 118 is, for example, disposed between the second light sources 114 and the light guide element 120. The first light condensing device and the second light condensing device are respectively for condensing the first light 122 and the second light 124.

More specifically, the light guide element 120 is disposed on the first light condensing device 116 and the second light condensing device 118. This disposition is for guiding the condensed first light 122 and the condensed second light 124 to the exit slit 126.

The optical engine 106 is disposed in the housing 102 and near the light module 104. The optical engine 106 is for receiving the light emitted from the light module 104, and is for generating an image. In the projector 100 of the first embodiment, the optical engine 106 comprises a light pipe 132, a color wheel 134, a lens module 136, a first reflection mirror 138a, a second reflection mirror 138b, a total reflection lens (TIR lens) 140, an imaging device 142 and a focusing lens 144. However, one skilled in the art understands that the optical engine of the invention need not be limited to comprise the above-mentioned devices. The scope of the invention is based on the appended claims.

The light pipe 132, disposed on the exit slit 126, is for receiving and homogenizing the light emitted from the light guide element 120. For example, the light pipe 132 emits the first light 122 and the second light 124 to and through the exit slit 126.

The color wheel 134 is for separating the light passing through the color wheel 134. The color wheel 134 may be disposed between the light pipe 132 and the lens module 136, as shown in FIG. 1. The color wheel 134 may be alternatively disposed between the light module 104 and the light pipe 132. In the projector 100 of the first embodiment, the first light 122 and the second light 124 pass through the color wheel. The colors of the passing first light 122 and the passing second light 124 are separated by the color wheel 134.

The lens module 136 is for receiving the light passing through the light pipe 132. After the light passes through the light pipe 132, the light is, for example, sequentially reflected by the first reflection mirror 138a, the second reflection mirror 138b and the TIR lens 140 to the imaging device 142.

The imaging device 142 is, for example, a digital micromirror device (DMD). The imaging device is for receiving the light and generating an image. The focusing lens 144 is for receiving the light emitted from the imaging device 142, and is for focusing the image onto the screen 150.

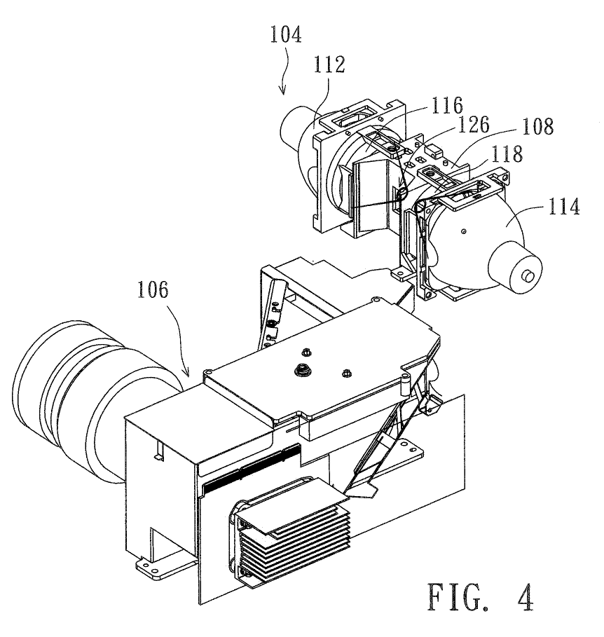

Reference is made to FIG. 4, which depicts a perspective view showing the detached light module and the projector in FIG. 2. Because the light module 104 is detachably disposed on the housing, the projector can be first-layered detached. That is, the light module 104 can be wholly detached. The light module 104 is detached by, for example, loosing the bolt fixed on the fixture 108 and the housing. The bolt is loosed for taking the light module 104 out of the projector 100. After the light module 104 is wholly detached and replaced by a new light module, the exit slit of the new light module is disposed on the same position of the exit slit of the original light module 104. The disposed light module can be operated with the original optical engine 106, it is therefore not necessary to design a new optical engine. There is a simple and clear interface between the light module 104 and the optical engine 106 in the projector 100 of the first embodiment. The interface simplifies the designing process of changing the light module 104, and saves the time and cost of designing a new optical engine Accordingly, the projector 100 is more compatible and expanded with different light modules.

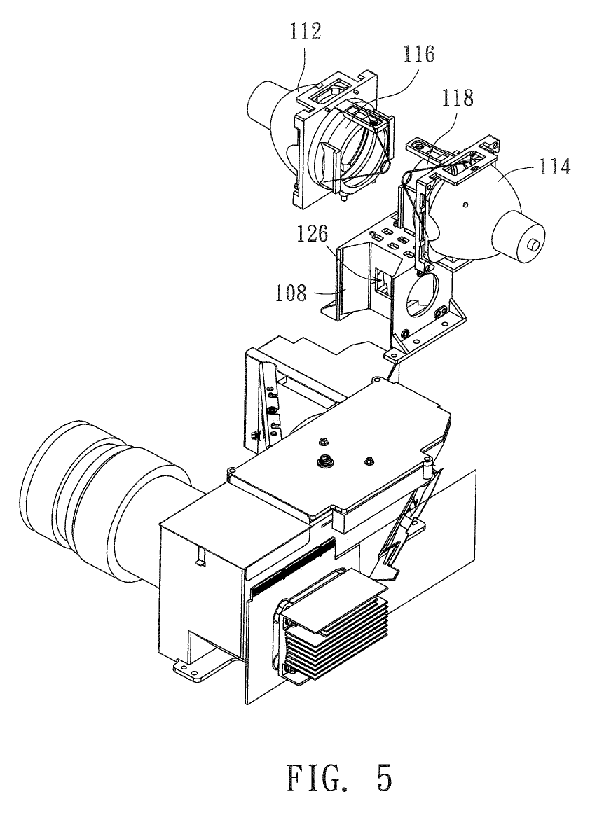

Reference is made to FIG. 5, which depicts a perspective view showing the detached first light source 112 and the detached second light source 114 and the projector 100 in FIG. 2. In the projector 100 of the first embodiment, the light source is detachably disposed on the light module 104, so that a second-layered detaching process can be performed in the projector 100. That is, the light source can be individually detached. The light source is detached by, for example, loosing the bolts fixing the first light source 112 and the second light source 114 on the housing to individually detach the first light source 112 and the second light source 114. The double-layered technology may be applied to a double-lamps or multi-lamps projector. If one light source of the double-lamps or multi-lamps projector is damaged, changing the one light source is enough to repair the projector. It is not necessary to change the whole light module, so that the repairing cost of the projector is reduced.

The invention is described according to the double-layered light module 104 of the first embodiment. However, the invention needs not be limited to the first embodiment. Any projector having a detachable light module is within the scope of the invention.

### Second Embodiment

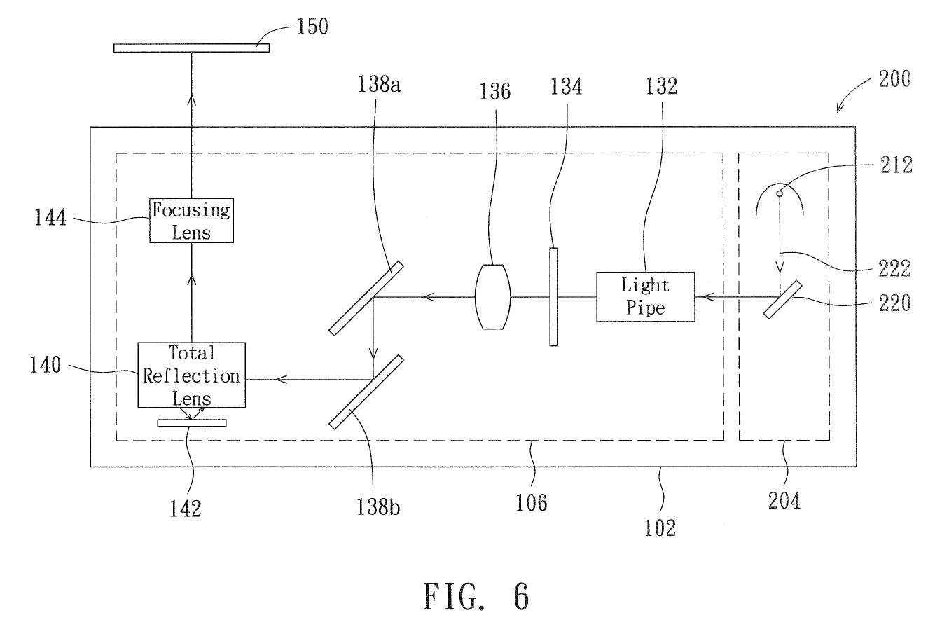

FIG. 6 schematically shows an optical path of a projector according to a second embodiment of the invention. Reference is made to FIG. 1 and FIG. 6, the difference between the projector 200 of the second embodiment and the projector 100 of the first embodiment is that the projector 200 is a single-lamp projector, rather than double-lamps projector of the first embodiment. More specifically, because the light module 100 of the double-lamps projector 100 can be wholly detached, the projector 200 of the second embodiment may comprises a housing 102 and an optical engine 106, which are respectively the same as those of the projector 100 of the first embodiment. In other words, the projector 200 may be obtained as long as the light module of the double-lamps projector is replaced by a light module having a single lamp. Therefore, different light modules are capable of being applied to the same optical engine. It is not necessary to change the design of the optical engine to accommodate different light modules.

In the projector 200 of the second embodiment, the light module 204 comprises a fixture, a light source 212 and a light guide element 220. The fixture may have an exit slit. The fixture may be detached disposed on the projector 200. The fixture is disposed by, for example, being screwed on the housing 102 with a bolt, so that the fixture is detachably disposed in the projector 200.

The light source 212, such as a lamp, is disposed on the fixture, is for emitting a light 222. The light source 212 may be fixedly disposed on the light module 204. Alternatively, the light source is detachably disposed on the fixture by, for example, being screwed on the fixture with a bolt, so that the light source 212 is detachably disposed on the light module 204.

Light guide element 220 is, for example, a reflection device. The light guide element 220, disposed on the fixture and near the light source 212, is for changing the emitting direction of the light 222 to guide the light 222 to the exit slit.

The optical engine 106, applied to the projector 200 of the second embodiment, is substantially the same as the optical engine 106 of the projector 100 of the first embodiment. The detailed description of the optical engine 106 is therefore omitted. Moreover, the light module 204 of the projector 200 of the second embodiment can be double-layered detached. That is, the light source 212 can be individually detached, or alternatively detached when the whole light module is detached.

The light module of the projector is detachable. That is, each of different light modules can be deposited on the same interface of the projector. Accordingly, the projector is more compatible and expanded with different light modules.

In a developing process of changing the design of the light module, the exit slit of the changed light module is disposed on the same position of the exit slit of the original light module. The disposed light module can be operated with the original engine, it is therefore not necessary to design a new optical engine. As an advantage, the manpower, cost and time of the developing process are saved. Moreover, changing the design of the light module is more simple and flexible than before.

On the other hand, the optical engine can accommodate different light modules. Accordingly, the optical engine can be first produced with a large number, and then be combined with different light modules. Such mass production reduces the cost of manufacturing projectors.

Additionally, the detachable light modules can be double-layered. The double-layered light module can be wholly detached or respectively detached. The double-layered technology may be applied to a double-lamps or multi-lamps projector. If one light source of the double-lamps or multi-lamps projector is damaged after being used for a period of time, changing the one light source is enough to repair the projector. It is not necessary to change whole light module, so that the repairing cost of the projector is reduced.

As is understood by a person skilled in the art, the foregoing preferred embodiments of the present invention are illustrated of the present invention rather than limiting of the present invention. It is intended that various modifications and similar arrangements be included within the spirit and scope of the appended claims, the scope of which should be accorded the broadest interpretation so as to encompass all such modifications and similar structure.

What is claimed is:

1. A projector assembly comprising:
a light module comprising:
a fixture;
at least a light source, disposed on the fixture, for emitting a light along a direction; and
a light guide element, disposed on the fixture and adjacent to the light source, for changing the direction of the light; and
an optical engine, disposed near the light module, for receiving the light emitted from the light guide element and for generating an image, wherein the fixture is detachably disposed on the projector, so that the light module is detachably disposed on the projector.

2. The projector assembly according to claim 1, wherein the light source of the light module is detachably disposed on the fixture.

3. The projector assembly according to claim 1, wherein the light module comprises two light sources disposed on two opposite sides of the fixture.

4. The projector assembly according to claim 3, wherein each of the light sources of the light module is detachably disposed on the fixture.

5. The projector assembly according to claim 3, further comprising two light condensing devices, wherein one of the light condensing devices is disposed between one of the light sources and the light guide element, and wherein another of the light condensing devices is disposed between another of the light sources and the light guide element.

6. The projector assembly according to claim 5, wherein the light condensing devices are two condensing lenses.

7. The projector assembly according to claim 1, wherein the light guide element is a prism or a fold mirror.

8. The projector assembly according to claim 1, wherein the optical engine comprises:
a light pipe for receiving and homogenizing the light emitted from the light guide element;
a lens module for receiving the homogenized light;
an imaging device for receiving the light emitted from the lens module to generate an image; and
a focusing lens for focusing the image on a screen.

9. The projector assembly according to claim 8, further comprising a color wheel, wherein the color wheel is disposed between the light pipe and the lens module for separating the color of the light.

10. The projector assembly according to claim 8, further comprising a color wheel, wherein the color wheel is disposed between the light module and the light pipe for separating the color of the light.

11. A projector comprising:
a housing;
a light module, detachably disposed in the housing, the light module comprising:
a fixture having an exit slit;
a first light source and a second light source, detachably disposed in the fixture, for respectively emitting a first light and a second light;
a first light condensing device and a second light condensing device, respectively disposed beside the first light source and the second light source, for condensing the first light and the second light; and
a light guide element, for guiding the condensed first light and the condensed second light to the exit slit; and
an optical engine, disposed in the housing and near the light module for receiving the first light and the second light emitted from the light module and for generating an image.

12. The projector according to claim 11, wherein the light condensing devices are two condensing lenses.

13. The projector according to claim 11, wherein the light guide element is a prism or a fold mirror.

14. The projector according to claim 11, wherein the optical engine comprises:
a light pipe for receiving and homogenizing the light emitted from the light guide element;
a lens module for receiving the homogenized light;
an imaging device for receiving the light emitted from the lens module to generate an image; and
a focusing lens for focusing the image on a screen.

15. The projector according to claim 14, further comprising a color wheel, wherein the color wheel is disposed between the light pipe and the lens module for separating the color of the light.

16. The projector according to claim 14, further comprising a color wheel, wherein the color wheel is disposed between the light module and the light pipe for separating the color of the light.
